(19) United States
(12) Patent Application Publication
(10) Pub. No.: US 2025/0035298 A1
(43) Pub. Date: Jan. 30, 2025

(54) ILLUMINATION DEVICE

(71) Applicant: Nanjing Chervon Industry Co., Ltd., Nanjing (CN)

(72) Inventors: Yafei Cao, Nanjing (CN); Yuexiang Zhang, Nanjing (CN); Xiujian Wu, Nanjing (CN)

(21) Appl. No.: 18/756,655

(22) Filed: Jun. 27, 2024

(30) Foreign Application Priority Data
Jul. 24, 2023 (CN) 202310916883.X
Jul. 24, 2023 (CN) 202321954463.2
Jul. 24, 2023 (CN) 202321959239.2
Jul. 24, 2023 (CN) 202321964127.6

(51) Int. Cl. F21V 29/76; F21V 23/02; F21V 31/00

(52) U.S. Cl. CPC F21V 29/763; F21V 23/02; F21V 31/005

(57) ABSTRACT

An illumination device includes a heat dissipation assembly at least partially disposed in a first accommodation space of a housing. The housing is provided with an air inlet for an airflow to enter the first accommodation space and an air outlet for the airflow passing through the airflow channel to flow out of the first accommodation space. The airflow channels are disposed along an up and down direction, and the air outlet is at least partially provided above the airflow channels.

### RELATED APPLICATION INFORMATION

This application claims the benefit under 35 U.S.C. § 119 (a) of Chinese Patent Application No. 202310916883.X, filed on Jul. 24, 2023, Chinese Patent Application No. 202321959239.2, filed on Jul. 24, 2023, Chinese Patent Application No. 202321964127.6, filed on Jul. 24, 2023, and Chinese Patent Application No. 202321954463.2, filed on Jul. 24, 2023, which applications are incorporated herein by reference in their entireties.

### TECHNICAL FIELD

The present application relates to a power tool and, in particular, to an illumination device for work.

### BACKGROUND

Illumination devices in the related art, especially work lights, are used for providing illumination for work regions that are difficult to illuminate. Due to the rapid development of technology, there is an increasing demand for the brightness of illumination devices in various fields. When the brightness is increased, a user does not want the time of endurance to be shortened. Therefore, the requirement on the endurance of a power supply becomes higher and higher.

This part provides background information related to the present application. The background information is not necessarily the existing art.

### SUMMARY

An illumination device includes: a housing having a first accommodation space; a panel assembly including light emitters and supported by the housing; a direct current power supply powering the light emitters, where a power supply coupling portion is disposed on the housing, and the direct current power supply is disposed on the power supply coupling portion; and a heat dissipation assembly at least partially disposed in the first accommodation space and including airflow channels at least partially disposed along an up and down direction for an airflow to flow through. The housing is provided with an air inlet for the airflow to enter the first accommodation space and an air outlet for the airflow passing through the airflow channels to flow out of the first accommodation space, and the air outlet is at least partially provided above the airflow channels.

In some examples, the heat dissipation assembly includes a heat dissipation substrate, where one side of the heat dissipation substrate fits snugly around the panel assembly, and multiple heat dissipation fins extending along the up and down direction are disposed on the other side of the heat dissipation substrate.

In some examples, at least part of materials of each of the heat dissipation fins are a thermally conductive plastic.

In some examples, the material of each of the heat dissipation fins is a thermally conductive plastic, and a metal sheet is attached to the outer side of the heat dissipation fin or is embedded in the heat dissipation fin.

In some examples, the thermal conductivity of the thermally conductive plastic is greater than or equal to 0.5 W/(m·K) and less than or equal to 2 W/(m·K).

In some examples, the illumination device further includes a lampshade covering the outer side of the panel assembly and sealingly connected to the heat dissipation substrate in a waterproof manner.

In some examples, each of the airflow channels is formed between two adjacent heat dissipation fins.

In some examples, the air outlet is provided on an upper portion of the housing along the up and down direction.

In some examples, the air inlet is provided on at least one side of the housing along a left and right direction, and the air inlet is configured to be lower than the air outlet along the up and down direction.

In some examples, the direct current power supply is disposed on the rear side of the panel assembly along the front and rear direction of the housing.

In some examples, the nominal voltage of the direct current power supply is greater than or equal to 36 V and less than or equal to 80 V.

In some examples, the direct current power supply is capable of powering a power tool, and the luminous flux of light emitted by the panel assembly at the maximum power is greater than or equal to 2000 lm and less than or equal to 5000 lm.

In some examples, the ratio of the luminous flux of light emitted by the panel assembly at the maximum power to the weight of a bare machine of the illumination device is higher than or equal to 1300 lm/kg and lower than or equal to 3000 lm/kg.

In some examples, the color temperature of the panel assembly is adjustable and is greater than or equal to 2500 K and less than or equal to 5000 K.

In some examples, the illuminance of the illumination device is greater than or equal to 300 lux and less than or equal to 1000 lux.

An illumination device includes: a housing having a first accommodation space; a panel assembly including light emitters and supported by the housing; a direct current power supply powering the light emitters, where a power supply coupling portion is disposed on the housing, and the direct current power supply is disposed on the power supply coupling portion; and a heat dissipation assembly at least partially disposed in the first accommodation space and including multiple heat dissipation fins at least partially extending along an up and down direction. At least part of materials of each of the heat dissipation fins are a thermally conductive plastic, and the thermal conductivity of the thermally conductive plastic is greater than or equal to 0.5 W/(m·K) and less than or equal to 20 W/(m·K).

An illumination device includes: a housing having a first accommodation space; a panel assembly including light emitters and supported by the housing; a lampshade covering the outer side of the panel assembly; a direct current power supply powering the light emitters, where a power supply coupling portion is disposed on the housing, and the direct current power supply is disposed on the power supply coupling portion; and a heat dissipation assembly including a heat dissipation substrate and multiple heat dissipation fins at least partially extending along an up and down direction. The lampshade is sealingly connected to the heat dissipation substrate in a waterproof manner. At least part of the multiple heat dissipation fins are disposed in the first accommodation space. An airflow channel for an airflow to flow through is formed between two adjacent heat dissipation fins. The housing is provided with an air outlet for the airflow to flow out of the first accommodation space via the airflow channel.

In some examples, at least part of materials of each of the heat dissipation fins are a thermally conductive plastic.

In some examples, the air outlet is at least partially provided above the airflow channel.

In some examples, the housing is provided with an air inlet for the airflow to enter the first accommodation space, and the air inlet is configured to be lower than the air outlet along the up and down direction.

An illumination device includes: a housing including a first surface for supporting the illumination device; a panel assembly including light emitters and supported by the housing; a direct current power supply powering the light emitters, where a power supply coupling portion is disposed on the housing, and the direct current power supply is disposed on the power supply coupling portion; and a support assembly including a support portion. The proximal end of the support portion is connected to the housing. The support portion has a protruding position for the support portion to protrude from the first surface and a storage position for the support portion to be stored in the housing. When the support portion is in the protruding position, the distal end of the support portion is far away from the first surface, and the support portion is capable of remaining in the protruding position to support the illumination device. The support portion cooperates with the first surface so that the illumination light-emitting angle of the illumination device is adjusted.

In some examples, the support assembly further includes a locking mechanism causing the support portion to remain in the storage position.

In some examples, the locking mechanism includes a limiting portion disposed on the housing and a receiving portion disposed on the support portion, and the limiting portion is connectable to or separable from the receiving portion.

In some examples, the proximal end of the support portion is rotatably connected to the housing, and an elastic member is disposed at the joint between the support portion and the housing and configured to cause the distal end of the support portion to constantly have a tendency to be far away from the first surface.

In some examples, the first surface is the bottom of the housing, and the distal end of the support portion moves from the direct current power supply to the panel assembly to be away from the first surface.

In some examples, the direct current power supply and the panel assembly are disposed along a front and rear direction, and the support portion is disposed between the direct current power supply and the panel assembly.

In some examples, when the support portion is in the protruding position, the angle a of inclination of the illumination device is greater than 0° and less than or equal to 45°.

In some examples, when the support portion is in the storage position, the support portion does not protrude from the first surface.

An illumination device includes: a housing including a first surface for supporting the illumination device; a panel assembly including light emitters and supported by the housing; a direct current power supply powering the light emitters, where a power supply coupling portion is disposed on the housing, and the direct current power supply is disposed on the power supply coupling portion; and a support assembly including a support portion. The proximal end of the support portion is connected to the housing. The support portion has a protruding position for the support portion to protrude from the first surface and a storage position for the support portion to be stored in the housing. The support portion is switched to the protruding position and the storage position so that the illumination device has different illumination light-emitting angles.

An illumination device includes: a housing including a first surface for supporting the illumination device; a panel assembly including light emitters and supported by the housing; a direct current power supply powering the light emitters, where a power supply coupling portion is disposed on the housing, and the direct current power supply is disposed on the power supply coupling portion; and a support assembly including a support portion. The proximal end of the support portion is connected to the housing. The support portion has a protruding position for the support portion to protrude from the first surface and a storage position for the support portion to be stored in the housing. The support portion is disposed between the direct current power supply and the panel assembly.

An illumination device includes: a housing including a first surface for supporting the illumination device; a panel assembly including light emitters and supported by the housing; a direct current power supply powering the light emitters, where a power supply coupling portion is disposed on the housing, and the direct current power supply is disposed on the power supply coupling portion; and a handle assembly disposed on the housing. The handle assembly includes multiple grips to be gripped. The handle assembly cooperates with the direct current power supply or the power supply coupling portion so that the illumination angle of the illumination device is adjusted.

In some examples, the handle assembly and the direct current power supply or the power supply coupling portion are capable of supporting the illumination device on a work surface.

In some examples, the handle assembly has a circular arc surface in contact with the work surface.

In some examples, the handle assembly includes a first handle and a second handle that are disposed on the left side of the housing and the right side of the housing, and the first handle or the second handle cooperates with the direct current power supply or the power supply coupling portion so that the illumination angle of the illumination device is adjusted.

In some examples, the first handle and the second handle are each configured to be bent toward the side of the direct current power supply.

In some examples, a third handle is disposed on the housing and connects the first handle to the second handle.

In some examples, the direct current power supply and the panel assembly are disposed along a front and rear direction, and the handle assembly is disposed between the direct current power supply and the panel assembly.

In some examples, the handle assembly is formed through gas-assisted molding.

An illumination device includes: a housing including a first surface for supporting the illumination device; a panel assembly including light emitters and supported by the housing; a direct current power supply powering the light emitters, where a power supply coupling portion is disposed on the housing, and the direct current power supply is disposed on the power supply coupling portion; and a handle assembly disposed on the housing. The handle assembly includes multiple grips to be gripped and is configured to surround at least the left side, upper portion, and right side of the periphery of the housing.

In some examples, the left side of the handle assembly or the right side of the handle assembly cooperates with the direct current power supply or the power supply coupling portion so that the illumination angle of the illumination device is adjusted.

An illumination device includes: a housing including a first surface for supporting the illumination device; a panel assembly including light emitters and supported by the housing; and a direct current power supply powering the light emitters, where a power supply coupling portion is disposed on the housing, and the direct current power supply is detachably disposed on the power supply coupling portion. After the direct current power supply is detached from the illumination device, the weight of the illumination device is set as the weight of a bare machine. The direct current power supply is capable of powering a power tool. The luminous flux of light emitted by the panel assembly at the maximum power is greater than or equal to 2000 lm and less than or equal to 5000 lm. The ratio of the luminous flux of light emitted by the panel assembly at the maximum power to the weight of the bare machine of the illumination device is higher than or equal to 1300 lm/kg and lower than or equal to 3000 lm/kg.

An illumination device includes: a housing for supporting the illumination device; a panel assembly including light emitters and supported by the housing, where the color temperature of the panel assembly is greater than or equal to 2500 K and less than or equal to 5000 K and is adjustable; and a direct current power supply powering the light emitters, where a power supply coupling portion is disposed on the housing, and the direct current power supply is detachably disposed on the power supply coupling portion. The nominal voltage of the direct current power supply is greater than or equal to 36 V and less than or equal to 80 V. After being detached from the illumination device, the direct current power supply is capable of powering a power tool.

### BRIEF DESCRIPTION OF THE DRAWINGS

FIG. 1 is an isometric view of an illumination device provided by the present application;

FIG. 2 is an exploded view of an illumination device provided by the present application;

FIG. 3 is a sectional view of an illumination device provided by the present application;

FIG. 4 is a structural view of a heat dissipation assembly provided by the present application;

FIG. 5 is a structural view showing that a panel assembly is connected to a heat dissipation assembly provided by the present application;

FIG. 6 is a side view of a support portion provided by the present application in a storage position;

FIG. 7 is a bottom view of a support portion provided by the present application in a storage position;

FIG. 8 is a side view of a support portion provided by the present application in a protruding position;

FIG. 9 is a bottom view of a support portion provided by the present application in a protruding position;

FIG. 10 is a front view of an illumination device provided by the present application;

FIG. 11 is a top view of an illumination device provided by the present application; and

FIG. 12 is a schematic view showing that a handle assembly and a power supply coupling portion provided by the present application are supported on a work surface.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies. one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

To clearly illustrate technical solutions of the present application, up, down, left, right, front, and rear are defined in the drawings of the specification.

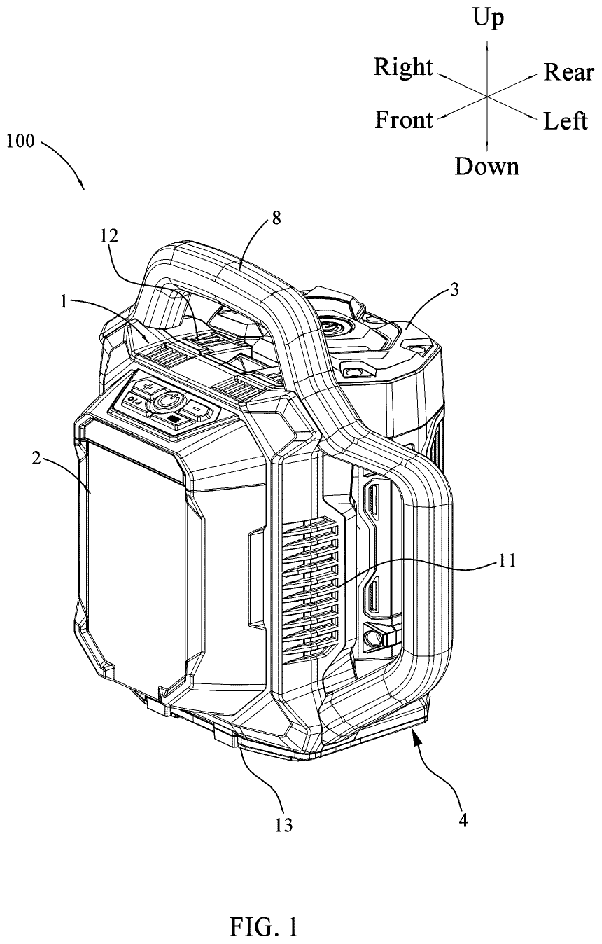

As shown in FIGS. 1, 2, and 3, the present application provides an illumination device 100 including a direct current power supply 3. The illumination device 100 is used for illuminating a work region. The illumination device 100 is a portable work light. When a user needs to work outdoors, the user may carry the illumination device 100 to the outdoors, thereby satisfying illumination requirements. The illumination device 100 in this example is different from a desk lamp. The desk lamp is commonly placed on a desktop for illumination while the illumination device 100 in FIG. 1 commonly stands on the ground to illuminate the work region when in use. Therefore, the illumination device 100 may also be referred to as a ground work light.

The illumination device 100 may be powered by a battery pack. Thus, even when the user works outdoors and no mains electricity is available around, the battery pack can be used for powering the illumination device 100 so that it is convenient to use the illumination device 100. Therefore, the illumination device 100 is different from an existing lamp that can be powered only by an alternating current, and the illumination device 100 may also be referred to as a direct current illumination device 100. Of course, it is to be understood that the illumination device 100 is not limited to the power supplied by only the direct current power supply. The illumination device 100 can be powered by the direct current power supply or the alternating current.

The illumination device 100 includes a housing 1, a panel assembly 2, the direct current power supply 3, and a heat dissipation assembly 5. The housing 1 has a first accommodation space 14 and supports the panel assembly 2. The panel assembly 2 is mounted on the housing 1 and includes light emitters 21. The light emitters 21 are configured to face the outer side of the first accommodation space 14. The lampshade 6 covers the outer side of the panel assembly 2. The lampshade 6 is light-transmissive, so light emitted by the light emitters 21 can be transmitted out through the lampshade 6. In some examples, the lampshade 6 is made of a transparent material. In some examples, the lampshade 6 is a structure that is opaque but light-transmissive so that the brightness and color rendering index of the light emitted by the illumination device make human eyes feel more comfortable.

The illumination device 100 includes the direct current power supply 3. The direct current power supply 3 is configured to supply electrical energy to the illumination device 100. In an optional example, the direct current power supply 3 is a battery pack. The battery pack cooperates with a corresponding power supply circuit to power the illumination device 100. It is to be understood by those skilled in the art that the power supply is not limited to the direct current power supply, and the corresponding components in the machine may be powered through mains electricity or an alternating current power supply in cooperation with corresponding rectifier, filter, and voltage regulation circuits.

For example, the direct current power supply 3 powers the light emitters 21. A power supply coupling portion 4 is disposed on the housing 1, and the direct current power supply 3 is disposed on the power supply coupling portion 4. The direct current power supply 3 can be detachably connected to the power supply coupling portion 4 so that it is convenient to replace the direct current power supply 3 and the service life of the illumination device 100 is prolonged.

In some examples, the direct current power supply 3 is disposed on the rear side of the panel assembly 2 along the front and rear direction of the housing 1 and does not interfere with the arrangement of another component.

In this example, the nominal voltage of the direct current power supply 3 is greater than or equal to 36 V and less than or equal to 80 V. In some examples, the direct current power supply 3 is the battery pack. In the following description, the direct current power supply is replaced with the battery pack 3, which is not intended to limit the present invention. The battery pack 3 is rechargeable. In some examples, the battery pack 3 may be a lithium battery pack, a solid-state battery pack, or a pouch battery pack. The nominal voltage generally refers to the voltage specified by the manufacturer or the vendor through the label, packaging, user manual, specification, advertisement, marketing document, or another support document of each of the products so that the user knows which electrical tools can run with the battery pack. Alternatively, the nominal voltage of the battery pack may be detected or calculated. The nominal voltage may be the voltage of the battery pack at the time when the state of charge (SOC) of the battery pack is 50%. For example, the nominal voltage of the battery pack 3 is greater than or equal to 36V and less than or equal to 80 V. For example, the nominal voltage of the battery pack 3 includes 48 V, 56 V, and 72 V.

In this example, the battery pack 3 may further power another power tool, that is to say, the battery pack 3 is an all-purpose battery pack 3 for power tools. The power supply coupling portion 4 includes a connection interface and a connection locking structure for the battery pack 3. The connection interface and the connection locking structure are the same as or interchangeable with the battery pack connection interface of the power tool and the connection locking structure of the power tool, respectively. Thus, the battery pack 3 can power a variety of different power tools and the illumination device 100. The power supply circuit cooperating with the battery pack 3 is adjusted according to control requirements of different power tools. With this configuration, it is unnecessary for the user to carry multiple types of battery packs 3, chargers, and adapters during a project operation. In this example, the power tool may be a garden tool, for example, a string trimmer, a blower, a rear-moving power tool such as a mower, a chainsaw, and a washer. Alternatively, the power tool may be a decoration tool, for example, screwdrivers/drills/wrenches, an electric hammer, a nail gun, or a sander. Alternatively, the power tool may be a sawing tool, for example, a reciprocating saw, a jigsaw, or a circular saw. Alternatively, the power tool may be another table tool, for example, a table saw, a metal cutter, or a router. Alternatively, the power tool may be a sanding tool, for example, an angle grinder or a sander. Alternatively, the power tool may be another power tool, for example, a fan or a work light. Alternatively, the power tool may be walking equipment that does not travel on roads, for example, a multi-purpose vehicle, may be a dune buggy, a utility vehicle (UTV), a golf cart, an all-terrain vehicle (ATV), or may be an agricultural machinery vehicle, for example, a harvester or a sprayer. Of course, it is to be understood that the walking equipment may be a washer. Alternatively, the power tool may be a smart walking power tool that is powered by the battery pack 3 to be driven to walk and implement a work function, for example, a smart mower. The power tool may be a power head powered by the battery pack 3. The power head is configured to be adapted to some output assemblies to implement the function of the tool.

In this example, the heat dissipation assembly 5 is at least partially disposed in the first accommodation space 14 and includes airflow channels 51 at least partially disposed along an up and down direction for an airflow to flow through. The housing 1 is provided with an air outlet 12 for the airflow to flow out of the first accommodation space 14 via the airflow channels 51. The air outlet 12 is at least partially provided above the airflow channels 51. Since the air outlet 12 is at least partially provided above the airflow channels 51 and high-temperature air moves up, the high-temperature air can be discharged from the air outlet 12 above the airflow channels 51, thereby improving heat dissipation efficiency.

In some examples, the housing 1 is provided with an air inlet 11 for the airflow to enter the first accommodation space 14. The airflow channels 51 are disposed along the up and down direction, and the air outlet 12 is at least partially provided above the airflow channels 51. As shown in FIG. 3, dashed lines in the figure show airflow paths. Air entering via the air inlet 11 flows through the airflow channels 51. Since the high-temperature air moves up, air whose temperature increases can be discharged from the air outlet 12 above the airflow channels 51. Negative pressure is formed in the first accommodation space 14, and cold air is sucked from the air inlet 11 into the first accommodation space 14 to supplement the air, thereby implementing circulation and ventilation in the first accommodation space 14 and achieving the effect of high-efficient heat dissipation.

In some examples, the air outlet 12 is provided on an upper portion of the housing 1 along the up and down direction. That is, the air outlet 12 is provided above the airflow channels 51, and the high-temperature air moves up and is discharged from the air outlet 12.

The panel assembly 2 is disposed on the front side of the housing 1, and the direct current power supply 3 is disposed on the rear side of the housing 1. Therefore, the air inlet 11 is provided on at least one side of the housing 1 along a left and right direction, and the air inlet 11 is configured to be lower than the air outlet 12 so that the cold air circulates in the housing. The panel assembly 2 is configured to be at least partially embedded in the housing 1. The housing 1 includes a housing surface located on the upper side of the panel assembly 2, and the housing surface is the upper surface of the housing. The air outlet 12 is at least partially on the upper surface of the housing.

In some examples, an air inlet 11 is provided on each of two opposite sides of the housing 1, thereby increasing an air intake area and improving the heat dissipation efficiency. No other components are mounted on the left or right side of the housing 1. Interference with another component is avoided, and the air intake area of the air inlet 11 can be increased. In some other examples, air inlets 11 may be provided on a lower portion of the housing 1 along the up and down direction, the front side of the housing 1, and the rear side of the housing 1, which is not specifically limited here.

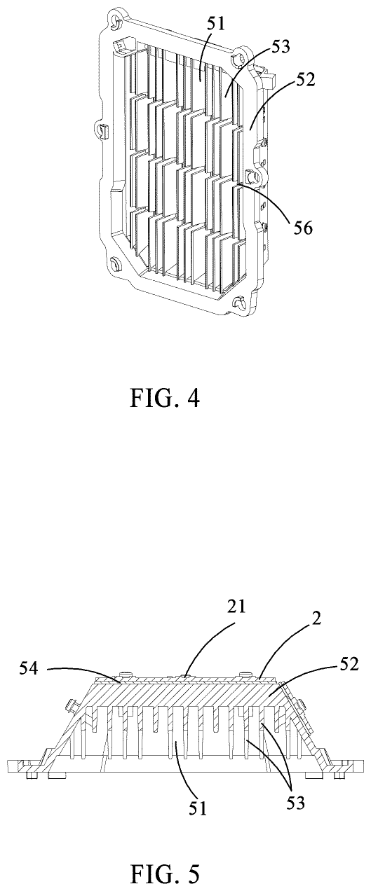

In some examples, as shown in FIGS. 3 to 5, the heat dissipation assembly 5 includes several heat dissipation fins 53 extending along the up and down direction. An airflow channel 51 is formed between two adjacent heat dissipation fins 53 for the airflow to flow through. This simple structure is easy to implement. Spacings between different pairs of two adjacent heat dissipation fins 53 may be the same. Different configurations may be performed on spacings between different pairs of two adjacent heat dissipation fins 53 according to the arrangement of the light emitters 21 on the panel assembly 2. The density of the heat dissipation fins 53 may also be configured according to the arrangement of the light emitters 21 on the panel assembly 2. The preceding configurations may be specifically adjusted according to different product structures and are not specifically limited.

At least part of materials of each of the heat dissipation fins 53 is a thermally conductive plastic which is light, inexpensive, and has a good heat dissipation effect. In some examples, the material of each of the heat dissipation fins 53 is the thermally conductive plastic. A metal sheet is attached to the outer side of each of the heat dissipation fins 53 or is embedded in each of the heat dissipation fins 53, thereby further improving the heat dissipation effect of the heat dissipation fins 53. In addition, each of the heat dissipation fins 53 is lighter and less expensive than a heat dissipation fin 53 that is completely made of metal. The metal sheet may be made of aluminum that has a good thermal conductivity property and is light.

The thermal conductivity of the preceding thermally conductive plastic is greater than or equal to 0.5 W/(m·K) and less than or equal to 20 W/(m·K). In some examples, the thermal conductivity of the thermally conductive plastic is greater than or equal to 1 W/(m·K) and less than or equal to 10 W/(m·K).

In some examples, the heat dissipation assembly 5 further includes a heat dissipation substrate 52 mounted on the housing 1. One side of the heat dissipation substrate 52 fits snugly around the panel assembly 2. The lampshade 6 is sealingly connected to the heat dissipation substrate 52 in a waterproof manner. The heat dissipation substrate 52 is at least partially disposed in the space of the lampshade 6.

The multiple heat dissipation fins 53 extending along the up and down and protruding from the heat dissipation substrate 52 are disposed on the other side of the heat dissipation substrate 52. At least part of the heat dissipation fins 53 are disposed in the first accommodation space 14, and the airflow channel 51 is formed between the two adjacent heat dissipation fins 53. The lampshade 6 covers the side of the heat dissipation substrate 52, where the panel assembly 2 is mounted on the side of the heat dissipation substrate 52. The lampshade 6 and the heat dissipation substrate 52 form a space for accommodating the panel assembly 2. The heat dissipation fins 53 are disposed in the first accommodation space 14 of the housing 1 and form a heat dissipation space with the first accommodation space 14. The heat dissipation space is independent of the space for accommodating the panel assembly 2. Thus, the heat dissipation efficiency is improved and the good heat dissipation effect is achieved.

The lampshade 6 covers the outer side of the panel assembly 2 and is sealingly connected to the heat dissipation substrate 52 in the waterproof manner. Thus, dust, water, or the like is prevented from entering the lampshade 6 to pollute the panel assembly 2 or even damage the panel assembly 2 and affect the normal working of the illumination device 100. In this example, the waterproof sealing level of the lampshade 6 and the heat dissipation substrate 52 reaches IPX4.

In some examples, the heat dissipation substrate 52 has a trapezoidal structure and is configured to be bent, and a recess is formed on the side of the heat dissipation substrate 52. The panel assembly 2 is mounted on the surface of the heat dissipation substrate 52, and the heat dissipation fins 53 are disposed in the recess. Mounting slots are provided at two ends of the heat dissipation substrate 52. Elastic seals 55 are disposed in the mounting slots. The elastic seals 55 are provided with insertion slots, and end portions of the lampshade 6 are inserted into the insertion slots. Since the elastic seals 55 can deform, the elastic seals 55 have a good waterproof sealing effect and can also function as connectors.

In some examples, a thermal pad 54 is also disposed between the panel assembly 2 and the surface of the heat dissipation substrate 52. The thermal pad 54 transfers the heat of the panel assembly 2 to the heat dissipation substrate 52, and the heat is dissipated out through the heat dissipation fins 53, thereby improving the heat dissipation efficiency.

In this example, the heat dissipation fins 53 are provided with airflow grooves 56 along the left and right direction. The multiple airflow grooves 56 are provided and arranged along the up and down direction. The spacings between the airflow grooves 56 may be equal or unequal to each other. In this example, the air inlet 11 is provided in the left and right direction. Therefore, the airflow grooves 56 are provided along the left and right direction so that it is more convenient for the airflow entering from the air inlet 11 to enter the airflow channels 51. In this example, the groove depth of each of the airflow grooves 56, that is, the depth of each of the airflow grooves 56 along a front and rear direction, is less than the height of each of the heat dissipation fins 53. It is to be understood that the bottom of each of the airflow grooves 56 does not communicate with the heat dissipation substrate 52.

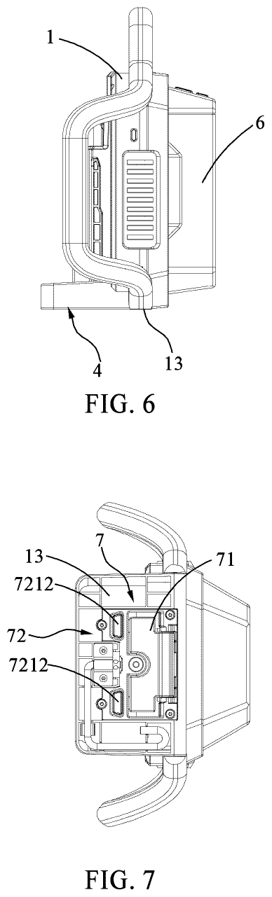

To enable the illumination device 100 to perform illumination from multiple directions and to enable the illumination angle of the illumination device 100 to be adjusted according to the use of the illumination device 100, as shown in FIGS. 6 to 9, a first surface 13 and a support assembly 7 that are used for supporting the illumination device 100 are disposed on the housing 1. The support assembly 7 includes a support portion 71. The proximal end of the support portion 71 is connected to the housing 1. The support portion 71 has a protruding position for the support portion 71 to protrude from the first surface 13 and a storage position for the support portion 71 to be stored in the housing 1. When the support portion 71 is in the protruding position, the distal end of the support portion 71 is far away from the first surface 13, and the support portion 71 can remain in the protruding position to support the illumination device 100. The support portion 71 cooperates with the first surface 13 so that the illumination light-emitting angle of the illumination device 100 is adjusted.

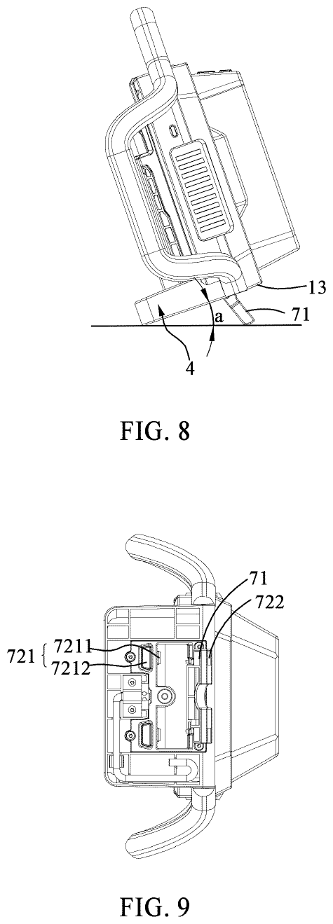

The support portion 71 is disposed on the housing 1. The support portion 71 has the protruding position (as shown in FIG. 6) for the support portion 71 to protrude from the first surface 13 and the storage position (as shown in FIG. 8) for the support portion 71 to be stored in the housing 1. As shown in FIG. 8, when the support portion 71 is in the protruding position, the support portion 71 can support the illumination device 100 so that the illumination angle of the illumination device 100 is changed. Thus, the illumination angle of the illumination device 100 is adjusted, thereby implementing multi-angle illumination of the illumination device 100. The support portion 71 is switched to the protruding position or the storage position so that the illumination device 100 has different illumination light-emitting angles.

The first surface 13 is the bottom of the housing 1. The distal end of the support portion 71 moves from the battery pack 3 to the panel assembly 2 to be far away from the first surface 13 so that the illumination device 100 inclines upward and the illumination light-emitting angle of the illumination device 100 is adjusted.

In some examples, the direct current power supply 3 and the panel assembly 2 are disposed along the front and rear direction. The support portion 71 is disposed between the direct current power supply 3 and the panel assembly 2. After the support portion 71 is in the protruding position and is supported on a work surface, the distal end of the support portion 71 and the direct current power supply 3 can achieve the support balance of force so that the illumination device 100 is stably supported on the work surface.

After the support portion 71 is in the protruding position and is supported on the work surface, the direct current power supply 3 or the power supply coupling portion 4 is also supported on the work surface, and the illumination device 100 inclines at an angle. Thus, the illumination device 100 has the different illumination light-emitting angles and can be stably supported on the work surface. The angle of inclination of the illumination device 100 is adjustable and may be adjusted through the adjustment of the position where the support portion 71 is supported on the work surface. The angle a of inclination of the illumination device 100 is greater than 0° and less than or equal to 45°. In some examples, the angle a of inclination of the illumination device 100 is greater than 0° and less than or equal to 30°.

In some examples, the proximal end of the support portion 71 is rotatably connected to the housing 1, and an elastic member is disposed at the joint between the support portion 71 and the housing 1. The elastic member is configured to cause the distal end of the support portion 71 to constantly have a tendency to be far away from the first surface 13. That is, the elastic member can cause the support portion 71 to be in the protruding position to support the illumination device 100.

As shown in FIGS. 6 and 7, when the support portion 71 is in the storage position, it is required to ensure that the support portion 71 is stored in the housing 1. Therefore, the locking mechanism 72 is disposed to cause the support portion 71 to remain in the storage position.

In some examples, the locking mechanism 72 includes limiting portions 721 disposed on the housing 1 and receiving portions 722 disposed on the support portion 71. The limiting portions 721 are connectable to or separable from the receiving portions 722.

As shown in FIG. 9, each of the receiving portions 722 includes a locking slot, and each of the limiting portions 721 includes a latch 7211 and a button 7212 connected to the latch 7211. The latch 7211 and the button 7212 are slidably disposed on the housing 1 separately. A spring (not shown) is further disposed between the button 7212 and the latch 7211 and can cause the latch 7211 to slide toward the receiving portion 722 and be engaged in the locking slot. Thus, the support portion 71 is locked. The button 7212 is pushed so that the latch 7211 can be caused to move away from the locking slot. Thus, the support portion 71 is unlocked.

In some other examples, each of the receiving portions 722 includes the locking slot, and each of the limiting portions 721 includes a stop block rotatably disposed on the housing 1. The stop block is rotated so that the stop block can be engaged in the locking slot or separated from the locking slot.

When the support portion 71 is in the storage position, the support portion 71 does not protrude from the first surface 13, and the first surface 13 of the illumination device 100 can be stably supported on the work surface.

As shown in FIG. 9, when the support portion 71 is in the protruding position, the distal end of the support portion 71 is far away from the first surface 13, the support portion 71 can remain in the protruding position to support the illumination device 100, and the limiting portions 721 are in the state of being connected to the receiving portions 722. When the support portion 71 needs to be locked, the button is pushed to cause the stop block to move away from the locking slot, the support portion 71 is stored in the storage position, and the button is released so that the stop block moves toward the support portion 71 and is engaged in the locking slot.

In this example, the support portion 71 causes the whole illumination device 100 to incline at the angle so that the illumination angle of the illumination device 100 is changed. In some examples, the support portion 71 may adjust the angle of inclination of the panel assembly 2 so that the illumination angle of the illumination device 100 is changed.

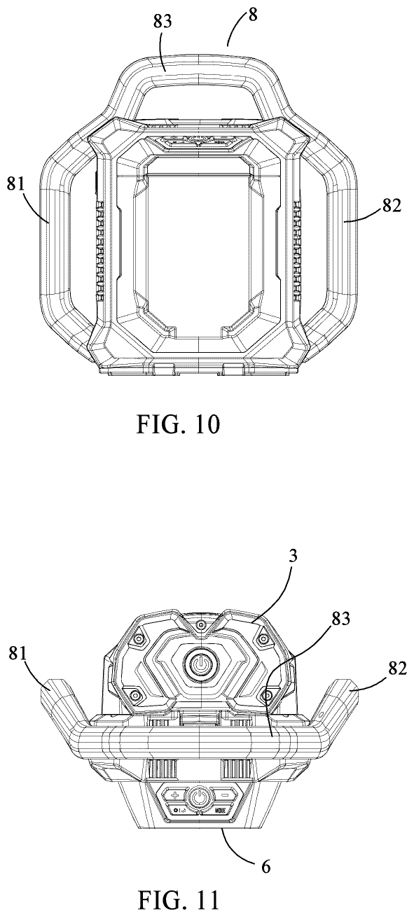

As shown in FIGS. 10 to 12, a handle assembly 8 is further disposed on the housing 1. The handle assembly 8 includes multiple grips to be gripped. The handle assembly 8 cooperates with the direct current power supply 3 or the power supply coupling portion 4 so that the illumination angle of the illumination device 100 is adjusted. Thus, the illumination device 100 has multiple illumination angles, thereby improving flexibility in the use of the illumination device 100.

The direct current power supply 3 and the panel assembly 2 are disposed along the front and rear direction. The handle assembly 8 is disposed between the direct current power supply 3 and the panel assembly 2 along the front and rear direction, which is an ergonomic design. When the illumination device 100 can be gripped and lifted through the handle assembly 8, the illumination device 100 can keep balance, and it is labor-saving for the user to carry the illumination device 100.

In some examples, the handle assembly 8 and the direct current power supply 3 or the power supply coupling portion 4 can support the illumination device 100 on the work surface so that the illumination angle of the illumination device 100 is adjustable.

The handle assembly 8 has a circular arc surface in contact with the work surface, avoiding the damage to the work surface and improving the comfort with which the user grips the handle assembly 8. In some examples, all surfaces of the handle assembly 8 are configured to be circular arc surfaces so that it is convenient for the user to grip the handle assembly 8 and the aesthetics of the illumination device 100 is further improved.

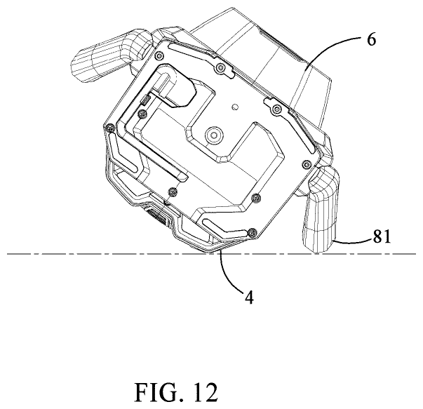

In some examples, the handle assembly 8 includes a first handle 81 and a second handle 82 that are disposed on the left side of the housing 1 and the right side of the housing 1. The first handle 81 or the second handle 82 cooperates with the direct current power supply 3 or the power supply coupling portion 4 so that the illumination angle of the illumination device 100 is adjusted. The difference between the preceding support portion 71 and the first handle 81 and the second handle 82 in the adjustment of the illumination angle of the illumination device 100 is that the illumination angle of the illumination device 100 is adjusted through the support portion 71 when the illumination device 100 stands while the illumination angle of the illumination device 100 is adjusted through the first handle 81 and the second handle 82 when the illumination device 100 lies, as shown in FIG. 12.

To cause the first handle 81 or the second handle 82 to cooperate with the direct current power supply 3 or the power supply coupling portion 4 to support the illumination device 100 stably on the work surface, both the first handle 81 and the second handle 82 are configured to be bent toward the side of the direct current power supply 3. In addition, when the illumination device 100 falls to the ground, the first handle 81 and the second handle 82 that are disposed on two sides of the direct current power supply 3 can protect the direct current power supply 3 and the panel assembly 2.

In some examples, a third handle 83 is disposed on the housing 1 and connects the first handle 81 to the second handle 82. The user grips the third handle 83 to transfer the illumination device 100 conveniently. To improve the aesthetics of the illumination device 100, the third handle 83 is connected to the first handle 81 and the second handle 82 evenly and smoothly. In addition, the surface of the third handle 83 is a circular arc surface, thereby improving the comfort with which the third handle 83 is gripped. The handle assembly 8 is configured to surround the left side, upper portion, and right side of the periphery of the housing 1. When the illumination device 100 falls down, the handles disposed around the housing 1 can protect the illumination device 100. In some other examples, a handle may also be disposed on another sidewall of the housing 1, which is not specifically limited here.

The preceding handle assembly 8 is manufactured through gas-assisted molding. Compared with ordinary injection molding, the gas-assisted molding does not require the outer side of the handle assembly 8 to be covered with rubber. In addition, the handle assembly 8 heated through the gas-assisted molding is lighter than a handle assembly 8 processed through the ordinary injection molding.

It is to be explained that the gas-assisted molding, that is, gas-assisted injection molding, refers to that an inert gas (typically nitrogen) is used for forming one or more hollow channels in a plastic component formed by the injection molding. At the end of the filling stage, the inert gas is injected into an uncured melt of a product. The gas travels along a path with the minimum resistance, and a relatively thick portion of the melt is filled with the gas channel. The pressure of the gas causes the plastic product to fit snugly around the surface of a mold cavity, and compensations for shrinkage are performed until the component is solidified. Finally, the gas is discharged into the atmosphere or recycled. With the gas-assisted injection molding, the weight of a molded plastic can be reduced, and the material of a thick-wall component is reduced (the weight and the cost) by 40%, thereby reducing the material cost. A molding period is shortened so that a production cost is reduced. The pressure in a mold is reduced, thereby reducing mold abrasion. A pressure is uniformly transferred through the gas during the whole molding process so that a part that has a relatively thick wall, for example, a rib or a stiffener, has a uniform thickness, and dents are eliminated. The pressure in the mold is reduced by 70%. Therefore, a mold clamping force is reduced. Thus, a larger mold is mounted on a relatively small machine. A mold stress is also reduced so that it can be relatively easy to achieve a low internal stress and low warp of a combination of a thick wall and a thin wall. Therefore, size stability is improved and deformation is avoided.

The material of the handle assembly 8 includes one of polypropylene, acrylonitrile butadiene styrene (ABS), high impact polystyrene (HIPS), polycarbonate, polypropylene carbonate (PPC), and nylon, which is a thermoplastic and can be used in the gas-assisted molding.

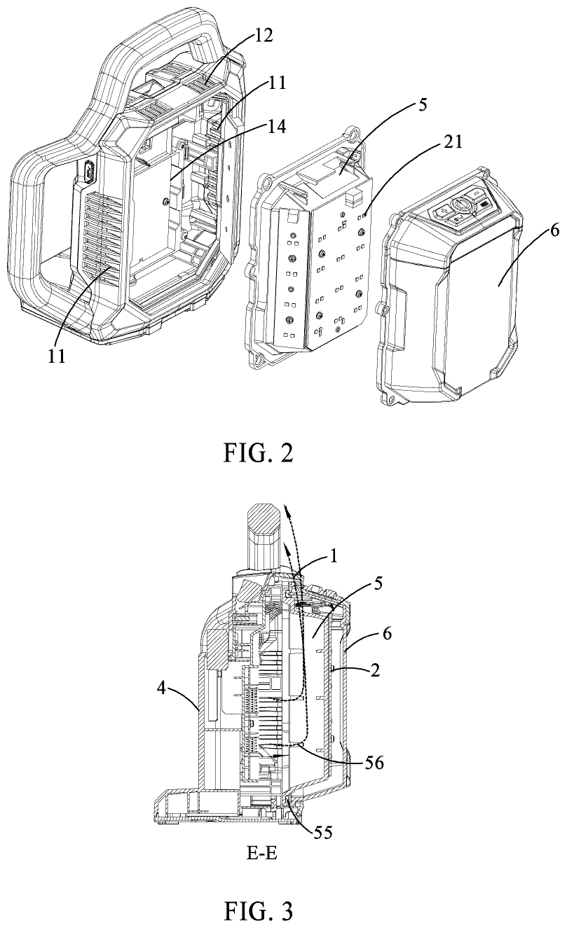

With continued reference to FIGS. 1 and 2, the preceding direct current power supply 3 is detachably connected to the power supply coupling portion 4. After the direct current power supply 3 is detached from the illumination device 100, the weight of the illumination device 100 is set as the weight of a bare machine. The direct current power supply 3 powers the light emitters of the panel assembly 2. The direct current power supply 3 may further power the power tool, thereby being capable of charging the power tool.

The luminous flux of light emitted by the panel assembly 2 at the maximum power is greater than or equal to 2000 lm and less than or equal to 5000 lm. The ratio of the luminous flux of light emitted by the panel assembly 2 at the maximum power to the weight of the bare machine of the illumination device 100 is higher than or equal to 1300 lm/kg and lower than or equal to 3000 lm/kg. The luminous flux of the light emitted by the panel assembly 2 at the maximum power is the maximum luminous flux that the panel assembly 2 can provide. In some examples, the luminous flux of the light emitted by the panel assembly 2 at the maximum power is greater than or equal to 2500 lm and less than or equal to 5000 lm. In some examples, the luminous flux of the light emitted by the panel assembly 2 at the maximum power is greater than or equal to 3000 lm and less than or equal to 5000 lm. The brightness of the illumination device 100 is set according to the size of the illumination device 100 so that the illumination brightness of the illumination device 100 is ensured and the endurance of the illumination device 100 is not affected.

The illuminance of the illumination device 100 is greater than or equal to 300 lux and less than or equal to 1000 lux. On the premise that the endurance of the illumination device 100 is ensured, the illumination brightness of the illumination device 100 is satisfied. In some examples, the illuminance of the illumination device 100 is greater than or equal to 450 lux and less than or equal to 950 lux. The color rendering index of the illumination device 100 is 80.

In some examples, the color temperature of the panel assembly 2 is adjustable so that the color of the light is adjustable according to use habits. The color temperature of the panel assembly 2 is greater than or equal to 2500 K and less than or equal to 5000 K.

Working currents of adjacent light emitters 21 are changed so that the color temperature of the panel assembly 2 is adjusted.

For example, the panel assembly 2 includes three lamp panels. Each of the lamp panels is electrically connected to a main control board. The direct current power supply 3 can power the main control board. Each of the lamp panels includes a row of warm light lamps and a row of white light lamps. A constant current source driver chip is configured to drive each row of lamps on each of the lamp panels. The main control board controls the brightness of each row of lamps through pulse-width modulation (PWM) signals, thereby adjusting the color temperature.

The illumination device 100 is further provided with a charging interface. In this example, the charging interface is provided on the housing 1. In another alternative example, the charging interface may be provided on the panel assembly 2.

An external device may be powered through the charging interface, for example, an electronic device of the user, including a mobile phone, a tablet, and a wearable device. When the user needs to charge the mobile phone, the mobile phone is placed on the housing 1 or in another position and connected to the charging interface through a data cable so that the mobile phone is charged through the charging interface. The charging interface is specifically one or more of a universal serial bus (USB) interface, a type-c interface, and a lighting interface. The battery pack 3 on the illumination device 100 may be charged through the charging interface. Thus, when it is inconvenient to charge the illumination device 100, the battery pack 3 may be charged by using the remaining power of the mobile phone or some other adaptable devices. Alternatively, the battery pack 3 is connected to an on-board power supply and charged by the on-board power supply. Alternatively, the illumination device 100 may be directly powered through the charging interface.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An illumination device, comprising:
a housing having a first accommodation space;
a power supply coupling portion disposed on the housing;
a panel assembly comprising light emitters and supported by the housing;
a direct current power supply powering the light emitters coupled to the power supply coupling portion; and
a heat dissipation assembly at least partially disposed in the first accommodation space and comprising airflow channels at least partially disposed along an up and down direction for an airflow to flow through;
wherein the housing is provided with an air inlet for the airflow to enter the first accommodation space and an air outlet for the airflow passing through the airflow channels to flow out of the first accommodation space, and the air outlet is at least partially provided above the airflow channels.

2. The illumination device according to claim 1, wherein the heat dissipation assembly comprises a heat dissipation substrate, one side of the heat dissipation substrate is attached to the panel assembly, and a plurality of heat dissipation fins extending along an up and down direction are disposed on another side of the heat dissipation substrate.

3. The illumination device according to claim 2, wherein at least a part of each of the plurality of heat dissipation fins comprises a thermally conductive plastic.

4. The illumination device according to claim 2, wherein each of the plurality of heat dissipation fins comprises a thermally conductive plastic, and a metal sheet is attached to an outer side of each of the plurality of heat dissipation fins or is embedded in each of the plurality of heat dissipation fins.

5. The illumination device according to claim 3, wherein a thermal conductivity of the thermally conductive plastic is greater than or equal to 0.5 W/(m·K) and less than or equal to 2 W/(m·K).

6. The illumination device according to claim 2, further comprising a lampshade covering an outer side of the panel assembly and sealingly connected to the heat dissipation substrate in a waterproof manner.

7. The illumination device according to claim 2, wherein each of the airflow channels is formed between two adjacent heat dissipation fins among the plurality of heat dissipation fins.

8. The illumination device according to claim 1, wherein the air outlet is provided on an upper portion of the housing along the up and down direction.

9. The illumination device according to claim 1, wherein the air inlet is provided on at least one side of the housing along a left and right direction, and the air inlet is configured to be lower than the air outlet along the up and down direction.

10. The illumination device according to claim 1, wherein the direct current power supply is disposed on a rear side of the panel assembly along a front and rear direction of the housing.

11. The illumination device according to claim 1, wherein a nominal voltage of the direct current power supply is greater than or equal to 36 V and less than or equal to 80 V.

12. The illumination device according to claim 11, wherein the direct current power supply is capable of powering a power tool, and luminous flux of light emitted by the panel assembly at maximum power is greater than or equal to 2000 lm and less than or equal to 5000 lm.

13. The illumination device according to claim 11, wherein a ratio of luminous flux of light emitted by the panel assembly at maximum power to a weight of a bare machine of the illumination device is higher than or equal to 1300 lm/kg and lower than or equal to 3000 lm/kg.

14. The illumination device according to claim 1, wherein a color temperature of the panel assembly is adjustable and is greater than or equal to 2500 K and less than or equal to 5000 K.

15. The illumination device according to claim 1, wherein illuminance of the illumination device is greater than or equal to 300 lux and less than or equal to 1000 lux.

16. An illumination device, comprising:
a housing having a first accommodation space;
a power supply coupling portion disposed on the housing;
a panel assembly comprising light emitters and supported by the housing;
a direct current power supply powering the light emitters disposed on the power supply coupling portion; and
a heat dissipation assembly at least partially disposed in the first accommodation space and comprising a plurality of heat dissipation fins at least partially extending along an up and down direction, wherein at least a part of each of the plurality of heat dissipation fins comprises a thermally conductive plastic, and thermal conductivity of the thermally conductive plastic is greater than or equal to 0.5 W/(m·K) and less than or equal to 20 W/(m·K).

17. An illumination device, comprising:
a housing having a first accommodation space;
a power supply coupling portion disposed on the housing;
a panel assembly comprising light emitters and supported by the housing;
a lampshade covering an outer side of the panel assembly;
a direct current power supply powering the light emitters disposed on the power supply coupling portion; and
a heat dissipation assembly comprising a heat dissipation substrate and a plurality of heat dissipation fins at least partially extending along an up and down direction,
wherein the lampshade is sealingly connected to the heat dissipation substrate in a waterproof manner, the plurality of heat dissipation fins are at least partially disposed in the first accommodation space, airflow channels for an airflow to flow through are formed between two adjacent heat dissipation fins among the plurality of heat dissipation fins, and the housing is provided with an air outlet for the airflow passing through the airflow channels to flow out of the first accommodation space.

18. The illumination device according to claim 17, wherein at least a part of each of the plurality of heat dissipation fins comprises a thermally conductive plastic.

19. The illumination device according to claim 17, wherein the air outlet is at least partially provided above the airflow channels.

20. The illumination device according to claim 19, wherein the housing is provided with an air inlet for the airflow to enter the first accommodation space, and the air inlet is configured to be lower than the air outlet along the up and down direction.
